(19) United States
(12) Patent Application Publication
(10) Pub. No.: US 2006/0291646 A1
(43) Pub. Date: Dec. 28, 2006

(54) Far-end control system and method of telephone exchange

(76) Inventors: Brian Yin, Hsin-chu (TW); Ryan Peng, Hsin-chu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/151,414

(22) Filed: Jun. 14, 2005

(51) Int. Cl. H04M 9/08

(52) U.S. Cl. 379/406.08

(57) ABSTRACT

The present invention discloses a far-end control system and method of telephone exchange, which comprises a controller exchange and a controllee exchange, wherein each exchange has a FSK transceiver, and a signal interconnecting relationship is formed between both exchanges via a telecommunication network. The controller exchange connects with a telephone set in the near end, transforms the keying signals of the telephone set into a string of FKS-encoded instructions, which are then transmitted to the far-end controllee exchange. The controllee exchange updates the system data according to the instructions and responds to the controller exchange with a string of FSK signals, which is then displayed on the telephone set. Via the transmission of FSK-encoded signals, and via the keying operations in the telephone set, the controller exchange can reprogram and control the controllee exchange from a far end. The present invention has advantages of easy and brief operation, diversified programming contents, cost saving, and time saving.

### BACKGROUND OF THE INVENTION

1. Field of the Invention

The present invention relates to a telephone exchange system, particularly to a far-end control system and method of telephone exchange, wherein the near-end exchange can reprogram the far-end exchange via the keying operations of the telephone set and the reciprocal transmission of FSK (Frequency Shift Keying) signals between both exchanges.

2. Description of the Related Art

At present, the most popular telecommunication instrument is the telephone, which enables people to perform voice communication between any two places. Telephone technology includes the following three portions: firstly, sending and receiving of voice signal in the telephone set; secondly, transmission of voice signal; thirdly, interchange of voice signal in the telephone exchange, and those three portions form a complete operation of telephone communication system, wherein the telephone exchange is the key of the entire telephone communication system and has a very important function.

In general, a commercial telephone system or a telephone exchange is provided by the dealer, and the reprogramming and maintenance thereof is usually performed by the technician of the dealer, who utilizes a telephone with LCD to reprogram an exchange, such as setting extension lines and numbers of extension telephones, directly from a near end in situ. However, reprogramming directly from the near end in situ results in that the user of the exchange has to spend time on waiting for the technician's maintenance or reprogramming; a far-end control system was thus developed.

The conventional far-end control system utilizes a computer with a modem, which is coupled to PSTN (public switched telephone network), to reprogram the database of a user-end exchange from a far end, and thus, the efficacy of reprogramming an exchange system from a far end can be accomplished. However, connecting with a computer and a modem will not only raise the cost and need a dial-up toll, but also bring about the problems of computer maintenance, management and system stability. Therefore, another far-end control system was also developed, wherein each of two distantly-spaced exchanges connects with a telephone set, and the dealer utilizes DTMF(Dual Tone Multi-Frequency) signals generated by telephone keys to reprogram the far-end exchange from the near-end exchange. However, as a set of DTMF signals can only carry sixteen kinds of data and the transmission rate thereof is low, the DTMF signal has disadvantage of long reprogramming time, and only simple reprogramming is available; thus it is hard for this conventional technology to perform a sophisticated reprogramming of the telephone system.

In re the aforementioned problems, the present invention proposes a far-end control system and method of telephone exchange to overcome the problems of the conventional technologies.

### SUMMARY OF THE INVENTION

The primary objective of the present invention is to provide a far-end control system and method of telephone exchange, which utilizes FSK signals to perform data transmission between two exchanges without any additional device and can reprogram and control a far-end exchange system just via simple operations of telephone keys so that the problems of the conventional technologies can be overcome.

Another objective of the present invention is to provide a far-end control system and method of telephone exchange, which does not need additional computer and modem and has the advantage of saving cost.

Yet another objective of the present invention is to provide a far-end control system and method of telephone exchange, wherein the programmed contents thereof is diversified and the operation time thereof is short.

Still another objective of the present invention is to enable different telephone systems to interconnect each other in order to perform a far-end reprogramming and control therebetween.

To achieve the aforementioned objectives, the present invention provides a controller exchange, which connects a telephone set, and a controllee exchange, wherein each exchange has a built-in FSK transceiver; the keying signals are transformed into FSK-encoded instructions by the FSK transceiver of the controller exchange, and the FSK-encoded instructions are then sent out; via a telecommunication network, the FSK-encoded instructions are received by the FSK transceiver of the controllee exchange; the system data of the controllee exchange is updated according to the instructions; a prompt message is then created and transformed into FSK signals to respond to the controller exchange via the telecommunication network, so that via the transmission of FSK-encoded signals and the operations of telephone keys, the controller exchange can reprogram and control the controllee exchange from a far end.

To enable the objectives, technical contents, characteristics and accomplishments of the present invention to be more easily understood, the preferred embodiments of the present invention are to be described below in detail in cooperation with the attached drawings.

### BRIEF DESCRIPTION OF THE DRAWINGS

FIG. 1 is a schematic diagram showing the system architecture of the far-end control system according to one aspect of the present invention.

FIG. 2 is a schematic block diagram showing the structure according to one aspect of the present invention.

### DETAILED DESCRIPTION OF THE INVENTION

The present invention utilizes FSK (Frequency Shift Keying) signals in the direct on-line communication between a near-end exchange and a far-end commercial telephone system and further utilizes a near-end telephone set to reprogram the far-end telephone system; the database of the far-end telephone system responds with a prompt message, which will be displayed on the telephone set, and the efficacy of controlling and reprogramming a far-end telephone system is thus accomplished.

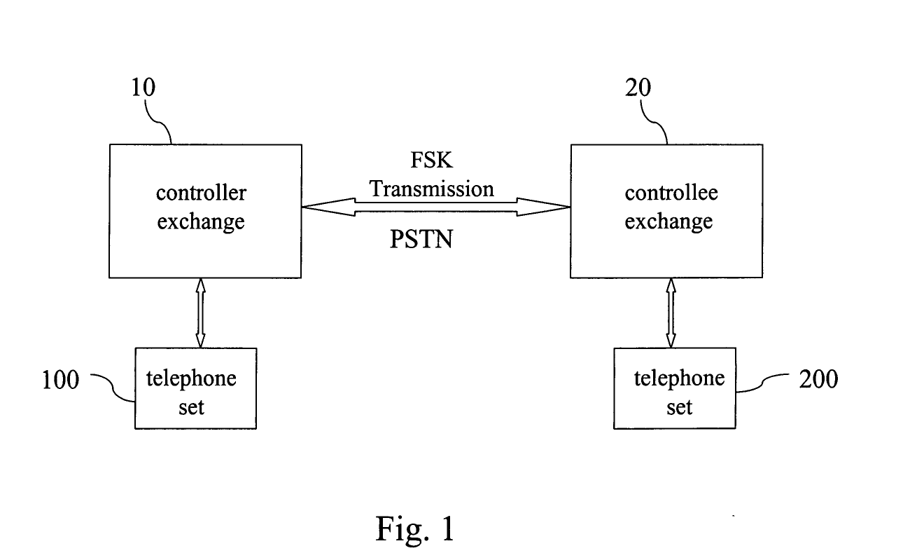

Referring to FIG. 1 a schematic diagram showing the system architecture according to one aspect of the present invention, the far-end control system of telephone exchange of the present invention comprises a controller exchange 10 and a controllee exchange 20, wherein the controller and controllee exchanges 10, 20 have identical internal structures and a signal interconnecting relationship is formed therebetween via coupling to PSTN (Public Switched Telephone Network). Two exchanges 10, 20 are separately connected with telephone sets 100, 200, which implement the keying operation and have display devices that are usually LCDs to present the reprogramming data.

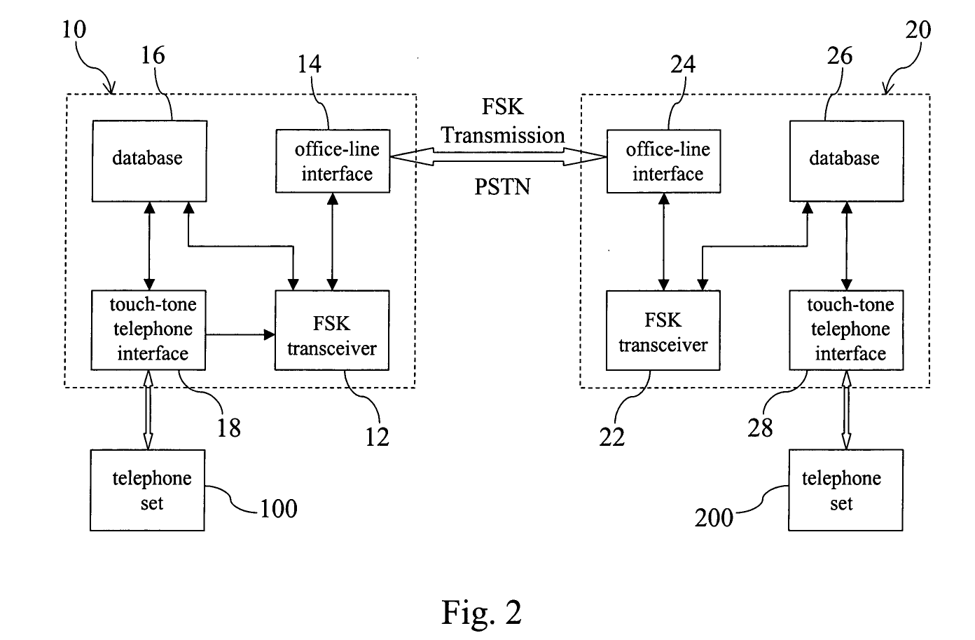

Referring to FIG. 2 a schematic block diagram showing the structure according to one aspect of the present invention, the controller exchange 10 has a built-in FSK transceiver 12, which is used to transmit and receive FSK-encoded signals; the FSK transceiver 12 is coupled to an office-line interface 14 and a database 16, which stores system data and is coupled to the telephone set 100 via a touch-tone telephone interface 18. When the controller exchange 10 is reprogrammed from the near end, the keying signal of the telephone set 100 is sent to the database 16 via the touch-tone telephone interface 18 to update the system data inside the database 16. When a far-end reprogramming is performed, keying signals input from the touch-tone telephone interface 18 is received by the FSK transceiver 12 and is transformed thereby into a string of FSK signals, which is further transmitted to the controllee exchange 20 via the office-line interface 14. The controllee exchange 20 also has a built-in FSK transceiver 22, which is used to transmit and receive FSK-encoded signals; the FSK transceiver 22 is coupled to an office-line interface 24 and a database 26, which is coupled to the telephone set 200 via a touch-tone telephone interface 28, wherein the operational relationship of the constituent elements of the controllee exchange 20 is the same as that of the controller exchange 10. The controller and the controllee exchanges 10, 20 are connected to PSTN separately via the office-line interface 14, 24, which enables the signal interconnecting relationship between the controller and the controllee exchanges 10, 20 to be formed, so that via the interconnecting by telecommunication network, and via the transmission of FSK-encoded signals, and via the keying operations in the telephone set 100, the controller exchange 10 can reprogram and control the controllee exchange 20 from a far end.

The aforementioned two exchanges 10, 20 respectively have databases 16, 26. If it is not a far-end but a near-end reprogramming that is to be performed, the telephone set 100/200 will reprogram the database 16/26, not via the FSK transceiver 12/22 and the office-line interface 14/24, but directly via the touch-tone telephone interface 18/28, which is a basic function originally possessed by the exchange 10/20. When a far-end reprogramming is to be performed, there is no direct relationship between the telephone set 100 and the database 16; the very target to be reprogrammed by the telephone set 100 is the database 26, and the response is generated not by the database 16 but by the database 26. Therefore, in the present invention, the databases 16, 26 separately in each end can be of different types, which will not hinder far-end reprogramming, i.e. in the antecedent of having the constituent elements mentioned above, the controller exchange 10 and the controllee exchange 20 can be of identical type or different types.

After the description of the system architecture and the near-end reprogramming procedure, the far-end control process is to be described below. When the keying operations of the telephone set 100 in the controller end is intended to reprogram and control the controllee exchange 20 from a far end, firstly, those two exchanges 10, 20 are connected with a central office line, wherein respectively via the office-line interfaces 14, 24, those two exchanges 10, 20 can be coupled to PSTN to enable a signal interconnecting relationship to be formed therebetween; then, when the controllee exchange 20 needs reprogramming, the user of the controllee end can dial the telephone set 200 to enable the controllee exchange 20 to connect with the controller exchange 10 via PSTN; once the linkage between those two ends is done, the controller end can use the telephone set 100 to reprogram the controllee exchange 20, wherein the telephone set 100 is used to input a keying signal, which is to be temporarily stored in the touch-tone telephone interface 18 of the controller exchange 10; the FSK transceiver 12 of the controller exchange 10 periodically transforms a set of keying signals into a string of FSK-encoded instructions, which is then transmitted to the controllee exchange 20; via the office-line interfaces 24, the FSK transceiver 22 of the controllee exchange 20 receives the FSK-encoded instructions, which is then stored into the database 26; and the controllee exchange 20 updates the system data of the database 26 according to the received FSK-encoded instructions.

When the database 26 is being updated, a prompt message, which is the recentest execution result including the reprogrammed system data, is created simultaneously; the FSK transceiver 22 will periodically transform the prompt message into a string of FSK-encoded signals, which is responded to the controller exchange 10; the prompt message will be displayed on the LCD of the telephone set 100; via the reciprocal transmission of the FSK-encoded signals between those two exchanges 10, 20 and the keying operations in the telephone set 100, the controller exchange 10 can access the database 26 of the far-end controllee exchange 20 in order to reprogram and control the far-end controllee exchange 20; and lastly, the central office line is disconnected, and the accessing activity is over.

Each time receiving and executing a string of FSK-encoded instructions transformed from the keying signals, the controllee exchange 20 will return a response, i.e. a prompt message, to the telephone set 100 in the controller end in order to present a picture showing the recentest execution data; then, the controllee exchange 20 proceeds to receive the succeeding string of FSK-encoded instructions to execute, with a response periodically returned to the telephone set 100 to display the picture of the recentest data. With respect to the periodical transmission of the FSK-encoded signals or the periodical return of the prompt message, the interval thereof will depend on the demand of the system, and usually, one string of FSK-encoded signals is transmitted or one picture is renewed every one second, so that the signals or data is virtually instantly transmitted or detected. In comparison with the conventional technology that only one response, or one or two characters are transmitted to renew the picture of the telephone set each time, the signal-detection technology of the present invention, wherein the advantage of FSK transmission is fully exploited, can periodically assemble multiple dispersed sets of data into a string of data to transmit, which not only can reduce the number of signal collision but also can raise the efficiency of signal transmission. In the other side, as it is not in the present invention that multiple strings of single execution instruction are all together transmitted in once, the quantity of message is not so large, and the data quantity in transmission is lessened, which reduces the collision opportunity obviously, and above all, the transmission rate is promoted.

Further, in the far-end control method of the present invention, those two exchanges 10, 20 can be of different types, wherein the systems of different versions can avoid interconnection failure, so that the systems of different versions can still be interconnected to perform the reprogramming and control from a far-end.

Accordingly, via that the present invention utilizes the built-in FSK transceiver as the interconnecting bridge to enable the keying signals of the near-end telephone set to be transmitted in FSK mode and to enable the reprogramming data of the far-end exchange to be responded to the the near-end telephone set in FSK mode, the present invention can accomplish the far-end reprogramming and control easily, economically, effectively and without any additional device. Further, the present invention adopts FSK signal for transmission, wherein a set of FSK signal can contain 256 pieces of instructions and the transmission rate of FSK signal is high, so that the present invention not only can overcome the transmission problems resulting from the conventional DTMF signal but also can diversify the programming contents and have the efficacy of shortening the operational time.

Those embodiments described above are to enable the persons skilled in the art to understand, make and use the present invention but not to limit the scope of the present invention. Any equivalent modification and variation according to the spirit of the present invention is to be included within the scope of the claims stated below.

What is claimed is:

1. A far-end control system of telephone exchange, which performs a far-end control via the transmission of FSK (Frequency Shift Keying) signals, comprising:
a controller exchange, coupled to a telephone set, and having a built-in first FSK transceiver, which transforms keying signals of said telephone set into a FSK-encoded instruction and sends out said FSK-encoded instruction; and
a controllee exchange, having a signal interconnecting relationship with said controller exchange via connecting to a telecommunication network, and having a built-in second FSK transceiver, which updates system data according to received said FSK-encoded instruction and transforms a prompt message created by the system into a FSK signal and responds said prompt message to said controller exchange via said telecommunication network;
wherein via the transmission of said FSK-encoded signals and the keying operations in said telephone set, said controller exchange can reprogram and control said controllee exchange from a far end.

2. The far-end control system of telephone exchange according to claim 1, wherein said telephone set implements keying operations and displaying function, which enables said prompt message created by said congtrollee exchange to be displayed on said telephone set.

3. The far-end control system of telephone exchange according to claim 1 or claim 2, wherein said prompt message further comprises the recentest execution result and the reprogrammed system data.

4. The far-end control system of telephone exchange according to claim 1,
wherein said controller exchange further comprises:
an office-line interface, coupled to said first FSK transceiver, and providing a connection to said telecommunication network;
a database, coupled to said first FSK transceiver, and providing a storage memory for said system data; and
a touch-tone telephone interface, coupled to said database, and providing a connection to a telephone set.

5. The far-end control system of telephone exchange according to claim 1,
wherein said controllee exchange further comprises:
an office-line interface, coupled to said second FSK transceiver, and providing a connection to said telecommunication network;
a database, coupled to said second FSK transceiver, and providing a storage memory for said system data; and
a touch-tone telephone interface, coupled to said database, and providing a connection to a telephone set.

6. The far-end control system of telephone exchange according to claim 1, wherein said first FSK transceiver periodically transmits a FSK-encoded instruction to said coltrollee exchange, and said second FSK transceiver periodically transmits a prompt message to said controller exchange.

7. A far-end control method of telephone exchange, which performs a far-end control via the transmission of FSK (Frequency Shift Keying) signals, comprising the following steps:
providing a first exchange and a second exchange, wherein said two exchanges have a far-end interconnecting relationship via a telecommunication network and said first exchange is coupled to a telephone set in the near end; and
after said first exchange is connected with said second exchange, said first exchange transforming a keying signal of said telephone set into a FSK-encoded instruction and transmitting said FSK-encoded instruction to said second exchange to enable said second exchange to update system data and respond to said first exchange with a FSK prompt message; wherein via the reciprocal transmission of said FSK-encoded signals between said two exchanges and the keying operations in said telephone set, said first exchange can reprogram and control said second exchange from a far end.

8. The far-end control method of telephone exchange according to claim 7, wherein said prompt message is displayed on said telephone set.

9. The far-end control method of telephone exchange according to claim 7 or claim 8, wherein said prompt message further comprises the recentest execution result and the reprogrammed system data.

10. The far-end control method of telephone exchange according to claim 7, wherein said second exchange can be connected with a telephone set.

11. The far-end control method of telephone exchange according to claim 7, wherein said first exchange periodically transmits a FSK-encoded instruction to said second exchange, and said second exchange periodically transmits a prompt message to said first exchange.
